(19) United States
(12) Patent Application Publication
(10) Pub. No.: US 2013/0061290 A1
(43) Pub. Date: Mar. 7, 2013

(54) SYSTEM FOR SECURELY PERFORMING A TRANSACTION

(71) Applicants: Jacob Mendel, Kibbutz Givat Brenner (IL); Alexander Potievsky, Kfar Saba (IL)

(72) Inventors: Jacob Mendel, Kibbutz Givat Brenner (IL); Alexander Potievsky, Kfar Saba (IL)

(21) Appl. No.: 13/470,704

(22) Filed: May 14, 2012

Related U.S. Application Data
(60) Provisional application No. 61/531,496, filed on Sep. 6, 2011.

(51) Int. Cl. G06F 21/00

(52) U.S. Cl. 726/4

(57) ABSTRACT

A system and method for performing a transaction are described. A transaction request to perform a transaction is received. Authorization information necessary to perform the transaction is gathered and stored in a secure memory. The gathered authorization information is verified. A final command to perform the transaction is received. When the final command is received, the transaction is performed and the stored authorization information in the secure memory is erased.

### 1. RELATED APPLICATIONS

The present patent application claims the benefit of the filing date under 35 U.S.C. §119(e) of provisional U.S. patent application Ser. No. 61/531,496, filed Sep. 6, 2011, which is hereby incorporated by reference.

### 2. TECHNICAL FIELD

This disclosure relates to systems and methods (generally referred to as systems) for performing a transaction. More specifically, this disclosure relates to a secured system for performing an authorized transaction.

### 3. BACKGROUND

For many years, significant advances in technology have driven strong growth in the availability and capability of electronic devices, as well as a steady and continual evolution in network infrastructure useful for the communication of these electronic devices. As just a few examples, it is not unusual for a consumer to own one or more cell phones, laptops, tablet computers, Global Positioning System (“GPS”) devices, gaming systems, and televisions, one or more of which may be capable of communicating with each other through a network, such as the Internet. Consumer electronics are only one segment of the total market for communicating electronic devices, and today such electronic devices are found virtually everywhere in society.

The advent of electronic devices and the continued expansion of networking between such devices have provided businesses and individual users with an expansive medium through which to promote commerce. Businesses and consumers may leverage these developments to enter contracts, conduct transactions, and arrange for the exchange goods or services electronically.

### BRIEF DESCRIPTION OF THE DRAWINGS

The system may be better understood with reference to the following drawings and description. In the figures, like reference numerals designate corresponding parts throughout the different views.

FIG. 1 is an exemplary block diagram of a network environment for performing transactions.

FIG. 2 is an exemplary block diagram of a device that incorporates a secured system for performing a transaction.

FIG. 3 is an exemplary flowchart of a method of using secured systems for performing a transaction.

FIG. 4 is an exemplary flowchart of a method of using a transaction monitor with a system for performing a transaction.

### DETAILED DESCRIPTION

Consumers, manufacturers, businesses, financial institutions, corporations, and/or various other users (“users”) may routinely perform or otherwise conduct various transactions electronically. With an increase in electronic transactions being performed, users can be exposed to hackers and risks of intrusions, theft, fraud, or compromised accounts or personal information. For example, when a transaction occurs through electronic components, some thieves or hackers will attempt to perform additional unauthorized transactions or hack a system to obtain personal or financial information about the consumer. The systems and processes described herein help protect against electronic transaction fraud, such as by tracking a number of transaction requests, requiring re-authorization for multiple requests to perform additional transactions, ratifying one or more legitimate transactions, and erasing personal and transactional related information between transactions.

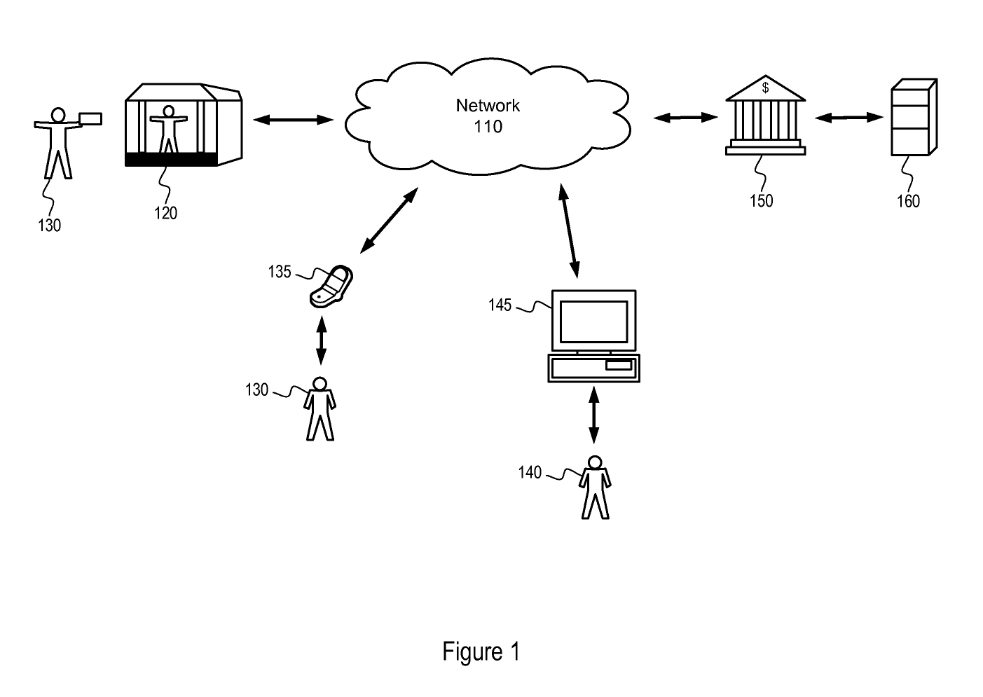

FIG. 1 is a block diagram of an example of a network environment in which users may interact and perform various transactions. One or more users, such as a business 120, a consumer 130, and a financial institution 150, may perform electronic transactions with each other, such as in person or through or over a wired or wireless network 110. Personal, authorization, and transactional information may be secured with any or all of the systems and processes described here.

Many users and types of transactions that can be vulnerable to fraud are possible. As an example, a consumer 130, through or using an electronic device 135 like a smart phone, computer, processor, personal digital assistant (“PDA”), or other devices such as a bank card or a credit card, may manage a bank account held at the financial institution 150. The consumer 130 may perform various types of transactions, such as depositing or withdrawing money from the bank account, transferring money from one or more accounts, requesting a cash advance, or generating a summary of the account balance.

As another example, a server for a credit card company may be configured or capable of performing various types of transactions for a consumer 130, such as a cash advance, credit card charge, or payment of a bill. The server can also be configured to perform one or more tasks or transactions for the credit card company, such as generating reports regarding users and credit lines, making payments to businesses requesting a transaction on behalf of a user, and various other tasks or transactions.

As another example of transactions that may be vulnerable to fraud, a consumer 130, through or using an electronic device 135, may electronically communicate and enter into a contract for goods or services with a business 120 over the network 110. A processor or server for a business 120 may provide a contract to the consumer 130, who may then be asked to electronically agree to and sign the contract, or perform one or more other transactions or tasks. Other examples of electronic transaction types that may be performed by or with one or more users may include, for example, electronically entering into contracts, purchasing or otherwise ordering various goods or services, managing various accounts, viewing or managing various medical reports, paying bills, requesting and tracking various shipments or transfers, monitoring a status of personal or public information, taking part in various online auctions, and performing or conducting various other transactions.

In some network environments, one or more thieves or hackers 140 may attempt to infiltrate the network 110, such as with or using an electronic device 145 like a computer, processor, smart phone, PDA, or other electronic device. A hacker 140 may monitor a user, a user's accounts, transaction information, or one or more transactions being performed over the network 110. As an example, a hacker 140 may monitor a consumer 130 or the consumer's bank account. When the consumer 130 subsequently enters personal information and authorizes a transaction involving the consumer's bank account, the hacker 140 may attempt to access or identify the authorization information or transaction information used with the transaction in order to perform one or more unauthorized transactions. For example, a hacker 140 may recognize and try to intercept a final command or digital signature necessary for performing a transaction, in an effort to try to attack, eliminate, or modify the command, either nullifying the transaction or performing a modified or different transaction using the consumer's authorization. As another example, the hacker 140 may wait until the first, authorized transaction has been completed using an authorized digital signature, and then attempt to replicate or use the same authorized digital signature to perform a subsequent, unauthorized transaction with the replicated digital signature. A consumer 130 may not be aware or have any defense from these types of illicit activities performed without authorization by a hacker 140. Various other risks or dangers may exist in conducting online or electronic transactions.

For users taking part in electronic or online transactions, it may be beneficial to perform such transactions through or using a secured system 160 configured or designed to protect against these risks and dangers. The system 160 may be configured to allow users, such as businesses 120, users 130, and financial institutions 150, to perform secure electronic transactions with each other. While the system 160 is shown as being in communication with the financial institution 150, in other systems and configurations, one or more systems 160 may be in communication with or directly used by various other users, such as the business 120 and/or the consumer 130.

The system 160 may be configured to allow a user to perform only one transaction for each authorization, which may prevent a thief or hacker 140 from tampering with or using a valid user authorization to perform invalid or unauthorized transactions. A transaction monitor in the system 160 may run in parallel with a transaction module performing the actions of the transaction, and may monitor all transaction information being sent to and from the system 160. The system 160 may temporarily store authorization and transaction information in a secure memory location only until the transaction has been completed, after which the system may immediately erase this information, such that a subsequent transaction may require re-authorization from a user. This may prevent a hacker 140 from nullifying or modifying a transaction, as well as from replicating or using previously provided authorization information a subsequent, unauthorized manner. Additionally, the system may protect a user in situations where a user attempts to perform a large transaction which, because of various limitations or security reasons, needs to be performed in two or more smaller transactions by requiring the user to authorize each of the two or more smaller transactions separately.

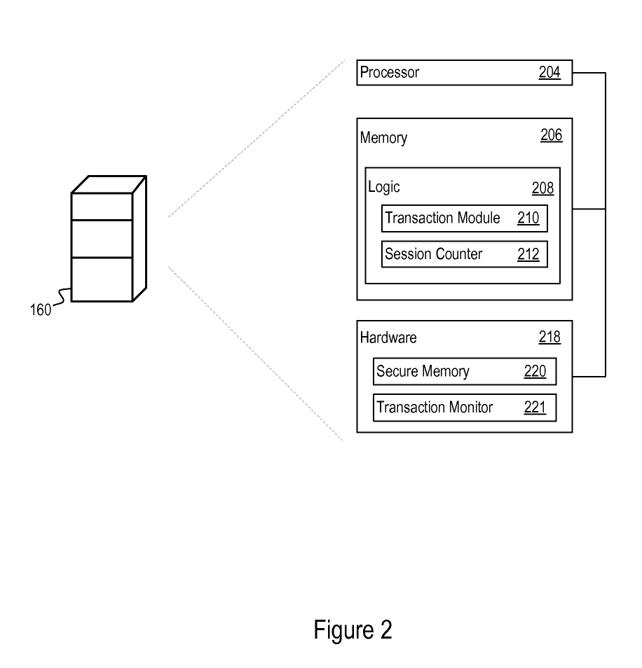

FIG. 2 is a block diagram of the system 160 which may be used for securely performing and/or ratifying a legitimate transaction. For explanatory purposes, the system 160 utilizing the secured system for performing a transaction may be a server, as shown in this example. In other systems, the system 160 may take any form.

The system 160 may include one or more of a processor 204, a memory 206, a transaction module 210, a session counter 212, a hardware 218, secure memory 220, and a transaction monitor 221. Fewer or more components may be included with the system 160.

The processor 204 may implement a software program, such as code or logic 208 generated manually (i.e., programmed) to control functionality a transaction module 210. The memory 206 may be operable to store instructions, code, or logic 208 executable by the processor 204 for implementing the transaction module 210. While the transaction module 210 is shown as logic 208, the transaction module 210 may also or alternatively be software, code, or other instructions which may, for example, be stored in or apart from memory 206, hardware, a microcontroller, a central processing unit (“CPU”), an application-specific integrated circuit (“ASIC”), or various other hardware components, software components, firmware components, or combinations of components.

The transaction module 210 may perform, monitor, guide, control, and/or otherwise conduct a transaction using the system 160. For example, the transaction module 210 may control the transaction, delegate system resources required for the transaction, and/or provide an interface or display to the user for transaction information, details, and prompts or requests for further user input.

In some systems, the transaction module 210 may generate, receive or transmit one or more commands or instructions for performing the transaction. One command or instruction may be identified, determined, or designated as a final command or instruction which may be necessary to perform the transaction. This final command or instruction key may indicate or signify that all input or actions required to perform the transaction have been completed. For example, where a consumer has requested a money withdrawal from the consumer's bank account, and where the transaction module 210 has verified the information provided by the consumer and necessary for authorizing the transaction, a final command may be sent by an ATM to a remote bank server, after which the bank server may deduct the requested amount from the consumer's bank account, and the ATM may dispense the requested money. Various other examples are possible.

A set of allowable or enabled commands may be predefined, such as in non-volatile memory. The set of commands and/or the non-volatile memory may be protected or further secured, for example, by a digital signature or transaction key. The digital signature or a transaction key may be attached to, associated with, or otherwise transmitted with one or more allowable transaction commands. When a command is transmitted or received, the transaction module 210 or the transaction monitor 221 may verify that the command is allowable or enabled using the digital signature or transaction key. For example, the transaction monitor 221 may identify a digital signature attached to a command and may verify that the digital signature is authentic and that the authenticated digital signature enables or otherwise allows for the command.

The digital signatures or transaction keys that may be used to enable or allow one or more commands may, for example, include or be made up from one or more pieces of information or data, one or more parameters, or any combination of them. For example, the digital signatures or transaction keys may be or include one or more of a hardware specific identification (ID), a signature of a hardware, an Application ID, Application information, personal information such as payment records, information acquired or based on a personal password or PIN, information from personal biometric data, log-in information, or various other information or combinations of information. Some or all of this information may be added, combined, arranged, and/or put together with or using a private key or secret key sign. The combination of data and the private key may be accomplished in various ways, such as, for example, via a Digital Signature Scheme, an International Organization for Standardization (“ISO”) 9796 scheme, an ISO 13239 scheme, and/or various other schemes. Where a symmetric private or secret key is used, a special certificate may be generated, the key or digital signature may be encrypted, and/or a special message authentication code (“MAC”) may be added on the certificate with another symmetric key which may be used or incorporated specifically for that procedure. In one example, a transaction key may be generated using a PIN code and a piece of personal identification information not normally stored or recorded by the requester or other systems. Various other examples are possible.

The system 160 may also include a session counter 212 to help secure transactions. The session counter 212 may ensure the transaction is performed in a given period of time. The session counter 212 may be configured to monitor or otherwise track a duration of a transaction. The duration of a transaction may, for example, be a length of time between the receipt of a transaction request by the system 160 and the receipt or transmission of the final command or final authorization to perform the transaction. In other systems, the duration may begin when a transaction module 210 is initialized, and/or may end when the transaction is actually performed or when data or information is erased from a secure memory 220. Various other examples are possible.

Session counter 212 may, for example, be a part of transaction module 210, and/or may be electronic data, code, or logic 208. In other systems, session counter 212 may be implemented using hardware, software, firmware, or a combination of one or more of these. The session counter 212 may, for example, be an electronic or processor clock, which may be started at the beginning of a duration of a transaction, such as when a transaction request is received or a transaction module 210 is initialized, and may be stopped at the end of the duration of the transaction, such as when the final command is received or the transaction is performed. Alternatively, the session counter 212 may be a counter which may begin at the start of a transaction and may increment periodically or at various time intervals until the end of the transaction. The session counter 212 may track one or more transaction parameters, such as a transaction duration and an order of actions of a transaction. In some systems, the transaction monitor 221 may monitor or track the session counter 212, and may perform one or more functions based on the session counter 212.

The session counter 212 may compare the tracked duration of a transaction to a threshold, such as a maximum duration threshold. The maximum threshold duration may represent a maximum time which may be allowed for conducting the transaction. This maximum threshold duration may represent an amount of time, after which, most valid requesters would have completed the transaction, and/or before which an intruder or hacker may not be anticipated to have infiltrated the transaction or authorization process. The session counter 212 may adjust the maximum duration threshold based on a type of transaction. In some systems, the session counter 212 may also or alternatively track a duration of one or more steps of a transaction.

The session counter 212 may additionally or alternatively be configured and/or capable of monitoring or otherwise tracking an order or set of actions or commands performed for a transaction. The session counter 212 may compare the order of actions or commands performed for the transaction to a desire or required order of actions or commands for the transaction. The session counter 212 may perform various other actions.

One or more of the session counter 212, the maximum duration threshold or other duration thresholds, and a desired order of actions of a transaction may be configured and/or modified based on the type of transaction. In some systems, one or more session counters 212 may be included for each type of transaction that may be performed or conducted by or using the system 160. For example, in some systems, a system 160 may have one session counter 212 for withdrawals from a bank account and a second session counter 212 for a deposit into a bank account. In other systems, one session counter 212 may be used and may operate the same for all types of transaction. Various other examples are possible.

At any time during a transaction, where a session counter 212 indicates that a duration has expired or exceeded a maximum duration threshold, or that a transaction has been performed out of order, the system 160 may perform one or more security actions. For example, the session counter 212 may alert the transaction module 210 and/or the transaction monitor 221. The transaction module 210 or the session counter 212 may send an alarm to the requester, the transaction monitor 221, and/or to the user interface 122 for display. As another example, the transaction monitor 221, which may monitor and detect when the session counter 212 indicates a problem with the transaction, may delete or erase all input authorization information collected and stored in the secure memory 220, as well as any and all other information related to the attempted transaction. The transaction module 210 may redirect a requester to a home or new log-in display, where the requester may start the transaction process over from the beginning. As another example, the transaction monitor 221 may erase all personal and other authorization information collected and may lock out the requester or freeze the system 160 or transaction module 210 from performing any further transactions without a hard restart from an authorized entity. Various other security actions are possible.

The system 160 may include a secure memory 220, which may be used to store one or more of transaction information, authorization information, and a digital signature or transaction key. The secure memory 220 may be a memory in hardware 218. The hardware 218 may protect the secure memory 220 and prevent attacks or unauthorized use of any information or data stored in the secure memory 220 in various ways. For example, the secure memory 220 may be protected using various encryption techniques. In some systems, the data or information that is being stored in the secure memory 220 may be written into the memory twice—the first time in a first way, and a second time in an inverse way, such as, for example, by reversing the order of the data or information. In some of these systems, the two instances of data or information may be written in different locations. The data or information may also be further encrypted in various ways, either before, at the same time as, or after determining an inverse of the data or information. In some systems, only some of the data or information may be written or stored twice, while other data or information may be written or stored only once.

The hardware 218 may also or alternatively perform an integrity check of the data stored in the secure memory 220. The hardware 218 may compare multiple instances of the same data or information to verify, confirm, or otherwise validate that the multiple instances represent the same information and have not been tampered with. The hardware 218 may perform various calculations, checks, or verifications of a digital signature and/or symmetric or asymmetric keys. For example, the hardware 218 may perform a cyclic redundancy check (“CRC”), a HASH calculation such as a secure hash algorithm (“SHA”) SHA-1, SHA-2, or other HASH calculation, a Rivest, Shamir, and Adleman (“RSA”) algorithm, digital signature algorithm (“DSA”), elliptic curve cryptography (“ECC”), or various other calculations to calculate, check, or verify a digital signature or asymmetric or symmetric keys. The hardware 218 may also or alternatively include a memory protection unit or a memory management unit which may also or alternatively be used to protect the secure memory 220 and/or any logic used or stored in the secure memory 220. In addition or alternatively, the hardware 218 and/or the secure memory 220 may be secured physically in various ways, such as with light sensors, temperature sensors, and various other sensors. Various other types of protection or security are possible.

The system 160 may also include a transaction monitor 221 which may be configured and/or used to monitor and control a transaction. The transaction monitor 221 may be operated in parallel with the transaction module 210 and may monitor all information and data being sent to or from the transaction module 210. The transaction monitor 221 may allow only one transaction to be conducted each time a requester authorizes a transaction, and may prevent double secure authorization transactions. The transaction monitor 221 may, after performance of the one authorized transaction, erase personal information used for authorizing a transaction, such as by wiping or erasing authorization and transaction information from the secure memory 220. The transaction monitor 221 may be a microcontroller, a CPU, an ASIC, various other hardware mechanisms or devices, logic, instructions, or software that may be executed by a processor, such as a processor 102, firmware, or various combinations of hardware, software, and firmware. Fewer or more components may be included with the system 160. The system 160 may control, monitor, and perform a transaction between or for one or more users in various ways, such as in the ways described that follow.

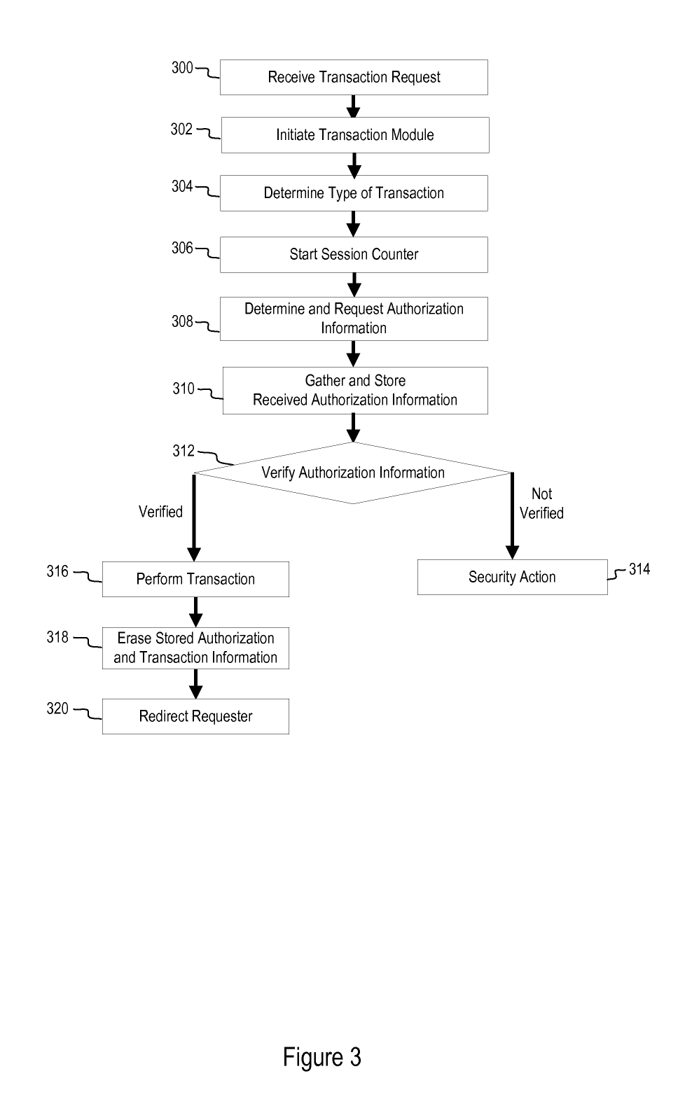

FIG. 3 is a flowchart of an example method of performing a transaction securely using the system 160. At block 300, a transaction request may be received or detected by the system 160. One or more users (“requesters”) may communicate a transaction request or other information to the system 160 in various ways. In a first way, a requester may interact with the system 160 directly, such as through or using a user interface. The system 160 may be an automated teller machine (“ATM”), and a requester may input data or information into the ATM using a card scanner or keypad connected with the ATM. In a second way, a requester may interact with the system 160 through one or more separate, independent, or distinct devices. The system 160 may be a server for a credit card company, and the requester may be a remote business 120 that is seeking to charge a consumer's credit card or other credit identification device such as a smart phone. In this example, the requesting business 120 may scan the consumer's credit card and input information and data into a credit card scanner or processor at the place of business. One or more pieces of credit card and inputted information may be sent to the credit card company's server system 160. For example, a name of the consumer 130, credit card number, PIN information, answers to security questions, information about the business 130 or types of purchases, etc. may be sent. In this example, the information or data may be sent or transmitted from the business's credit card scanner or processor over the network 110 to a server system 160 of the financial institution 150 or credit card company, such as by a wired communication system, wireless communication system, satellite system, the Internet, or various other systems or networks. Various other ways of communicating a transaction request or other information and data regarding the transaction are possible.

When the system 160 detects a transaction request, the method may proceed to block 302 where the transaction module 210 may be initiated or begin securing the transaction. In some systems, the transaction module 210 is initiated by one or more components of the system 160 that detect the transaction request and prompt the transaction module 210 to begin operation. In other systems, the transaction module 210 itself may run continuously or as manually programmed, and may detect, recognize, or otherwise identify when a transaction is being requested, after which the transaction module 210 may run or initiate transaction procedures. Various other examples are possible.

After detection of a transaction request and initiation or designation of the transaction module 210, the method may move to block 304 where the system 160 may identify or determine a type of transaction that is being requested. Identification of a type of transaction may be desired or necessary to determine, for example, what type of information may be needed to authorize the transaction, what settings to use with the session counter 212, and for various other reasons or setting determinations.

The transaction module 210 may identify or determine the type of transaction that is being requested in various ways. Identification of a type of transaction may be performed by monitoring an input that has been received from a requester. For example, a requester may select an “Initiate Cash Advance” button displayed to the user by an ATM, which the transaction module 210 may detect and identify as an input requesting a cash advance transaction. In other examples, the transaction module 210 may identify a type of transaction by identifying a type of requester that is requesting the transaction. For example, in some systems 160, one type of transaction may be performed when requested by a first consumer, a second type of transaction may be performed when requested by a second consumer, and a third type of transaction may be performed when requested by a business. In this example, identification of the transaction requester may be used by the transaction module to identify the type of transaction. Various other examples and methods of determining a transaction type are possible.

After block 304, the method may move to block 306 where the session counter 212 may be initiated or started, such as by or through a command sent by the transaction module 210. The session counter 212 may be configured and/or modified based on the type of transaction. The session counter 212 may track or monitor a duration of the transaction and/or an order of actions performed for the transaction. The session counter 212 may compare the duration of the transaction to a threshold, such as a maximum duration threshold. The session counter 212 may also or alternatively compare an order of actions performed for the transaction to a desired or required order of actions for the transaction.

After block 306, the method may proceed to block 308, where the transaction module 210 may identify or determine and request authorization information necessary to authorize and perform a transaction. Different types of transaction may require different authorization information. Examples of authorization information necessary for authorization for a transaction may include an account number, personal identification information such as an address or phone number, a personal identification number (“PIN”), a security password, a log-in or username, answers to one or more pre-selected personal questions, access conditions, randomly provided security codes or keys, and various other inputs, information, or data.

As an example, a transaction module 210 for an ATM system 160 that is configured to perform withdrawals may first identify that, in order to withdraw money from a consumer's bank account, the consumer must provide an electronic signature and a PIN number for the account that the consumer wishes to withdraw money from. Accordingly, the ATM system 160 may prompt a user to provide this necessary authorization information, such as with or using a display or other user interface 122. As another example, a transaction module 210 for a secured gaming server system 160 may identify that, in order to authorize a party to access secured gaming rights or opportunities, the party must provide a registered log-in name and password. Accordingly, the secured gaming server system 160 may prompt a user to provide this information, such as with or using a display or other user interface 122. Various other examples are possible.

At block 310, authorization information input, provided, received, transmitted, or otherwise submitted by a requester may be gathered. The received authorization information may be stored, for example, in a secure memory 220 of a hardware 218. Additionally or alternatively, throughout the transaction or at various points of time intervals, the hardware 218 and secure memory 220 may additionally or alternatively store transactional information. For example, the secure memory 220 may store session counter 212 information, threshold values, access credentials, intermediate calculations necessary to perform one or more steps of the transaction, commands performed, and various other pieces of transaction information. Storing authorization and transaction information in a secure memory 220 of the hardware 218 may be beneficial in that it may prevent an intruder from hacking, modifying, or otherwise changing the information or transactional steps in a manner that would otherwise be potentially possible if the personal information were instead stored in the transaction module 210, unsecure memory, or software.

At block 312, the system 160 may verify the authorization information received from the requester. The system 160 may, for example, store or access authorization credentials or expected authorization information, such as the PIN codes, passwords, or log-in information for the requester. Such authorization credentials or expected or necessary authorization information may be stored, for example, in a secure memory in the system 160, a secure memory or database separate from the system 160, or in various other locations. The transaction module 210 may compare the authorization information transmitted or input into the system 160 by a requester with the authorization credentials or expected authorization information accessed by the system 160. The transaction module 210 may also or alternatively compare or verify a digital signature or transaction key that is attached to each command transmitted or received for performing the transaction to verify that the command is valid, enabled, and/or allowed by the system 160.

Verification of the authorization information provided by the requester may be performed at various times. For example, the transaction module 210 may verify the authorization information as it is received by the system 160 or the transaction module 210. In other systems, the transaction module 210 may periodically, such as at various time intervals, verify the received authorization information. In other systems, the transaction module 210 may wait until all requested information has been provided by the requester before verifying the received authorization information. Various other examples are possible.

Where the authorization information collected does not match the necessary or expected authorization information, the method may move to block 314 where one or more security actions may be performed. For example, the transaction module 210 may send an alarm to the requester, the transaction monitor 221, and/or to the user interface 122 for display. As another example, the transaction monitor 221 may delete or erase all input authorization information collected and stored in the secure memory 220, as well as any and all other information related to the attempted transaction. The transaction module 210 may redirect a requester to a home or new log-in display, where the requester may start the transaction process over from the beginning. As another example, the transaction monitor 221 may erase all personal and other authorization information collected and may lock out the requester or freeze the system 160 or transaction module 210 from performing any further transactions without a hard restart from an authorized entity. Various other security features are possible.

Where the authorization information collected matches the necessary or expected authorization information, the method may move to block 316 where the transaction module 210 may proceed with performing the requested transaction. The transaction module 210 may not perform the requested transaction until the final command or final instruction has been generated, received, or transmitted and verified or confirmed as allowable or enabled by or through the digital signature or transaction key.

After performing the transaction, to help protected against fraud or hacking attempts, in block 318, the hardware 218 may erase all inputs, information, and data, including all personal or secret information necessary to authorize the transaction, from the secure memory 220. As an example, the transaction monitor 221 may monitor some or all of the actions, inputs, and actions of the transaction process, and may identify or detect when the final command or instruction has been generated, given, received, provided or otherwise transmitted and verified as allowed or enabled. Upon identifying or detecting the final command, the transaction monitor 221 and/or other hardware 218 may immediately or shortly thereafter erase all of the stored authorization information and/or any transaction information stored in the secure memory 220, including any final commands, instructions, digital signatures, or transaction keys. In some systems, the transaction module 221 may erase all authorization information and transaction information. In other systems, the transaction module 221 may only erase some of the transaction information, or some of the authorization information. Various other examples of erasing the stored authorization information and transaction information are possible.

Once the personal, transactional, and authorization information for the requester has been erased, wiped, or otherwise removed, the method may proceed to block 320 where the requester may be redirected. For example, the requester may be redirected to a home display, home page, or log-in page. If the requester desires to perform a second transaction, the requester may be required to re-complete the authorization actions previously discussed. In other methods, the requester may not be redirected, and instead a browser, web page, or display may be closed or turned off.

At various points throughout the method in FIG. 3, the session counter 212 or the transaction monitor 221 may detect one or more errors, inconsistencies, issues, problems, exceeded thresholds, or performance of actions out of a desired order of actions. For example the session counter 212 or the transaction monitor 221 may compare a tracked duration of transaction to a maximum duration threshold, and may detect when the tracked duration exceeds the maximum duration threshold. In some of these systems, when errors are detected by the session counter 212 or the transaction monitor 221, the method may proceed to block 314, where one or more security actions may be performed.

While block 306 is shown as being performed after block 304, in some methods, the actions of block 306 may be performed before or at the same time as the actions of block 304. Additionally, while the method of FIG. 3 shows blocks 304 and 306, in some methods, one or both of these blocks may not be included. For example, in some systems, a system 160 may only perform one type of transaction, and thus, no identification of a transaction type may be or may need to be performed by the system 160. In methods where one or both of these blocks are not included, the method may merely skip the missing blocks. Fewer or more actions may be included in various other methods, and in some methods, one or more actions may be performed in various other orders.

The system 160 may provide a benefit to a business or consumer by protecting the business or consumer from hackers that may perform unauthorized transactions using previously authorized data programs. The erasure of the personal information from the secure memory 220 may prevent hackers or intruders from performing additional transactions on behalf of the requester based on the authorization previously provided by the user. Hackers that may try to replicate or otherwise use the previously authorized digital signature to make an unauthorized transaction may be stopped, since the digital signature or any other personal information may be immediately erased after the one authorized transaction has been completed.

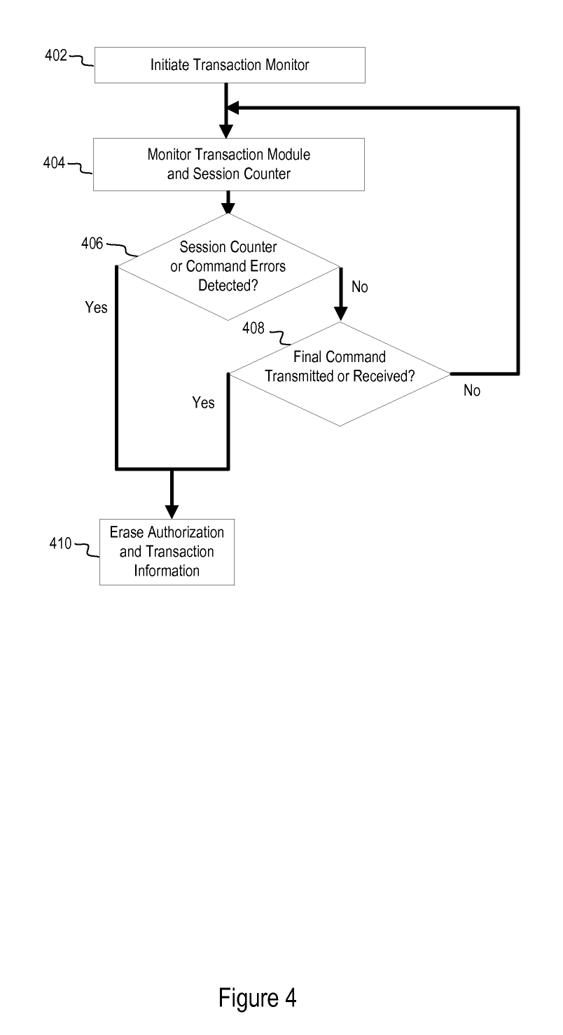

FIG. 4 is an example flowchart of a method of using a transaction monitor 221 with a system 160 for performing a transaction. The method may begin at block 402, where the transaction monitor 221 may be initiated. Initiation of the transaction monitor 221 may take place when a transaction request is received by a system 160 from a requester. In some systems, the transaction module 210 may send an alert or message to the transaction monitor 221 initiating or starting up the transaction monitor 221.

At block 404, the transaction monitor 221 may monitor the transaction module 210. For example, the transaction monitor 221 may track, monitor, identify, detect, verify, and/or review or analyze each command, action, or piece of information or data that is sent to or received by the transaction module 210 or otherwise pertaining to the transaction. The transaction monitor 221 may track or follow the actions, inputs, and information or commands of the transaction module 210 in parallel. The transaction monitor 221 may be configured to identify and take action when a final command or instruction is sent or performed for the transaction, indicating the final step in the transaction.

The transaction monitor 221 may also or alternatively monitor the session counter 212. For example, the transaction monitor 221 may track, monitor, identify, detect, and/or review or analyze information generated by or stored with the session counter 212, such as information about a duration of the transaction or a step of the transaction, or information about an order of the actions taken in a transaction.

The transaction monitor 221 may be configured to identify and take security actions when errors are detected, such as an inconsistency in an order of a transaction, an exceeded time limit for the transaction, an invalid or disallowed command, or various other errors.

At block 406, the transaction monitor 221 may determine whether a session counter or command error has been detected. If a session counter or command error, such as an inconsistency in an order of a transaction, an exceeded time limit for the transaction, or an improper or invalid command is detected, the method may proceed to block 410, where the transaction monitor 221 may erase all authorization and transaction information stored in the secure memory 220. In some systems, the transaction monitor 221 may erase this information. In other systems, the transaction monitor 221 may send a signal or instruction to a processor or other piece of hardware 118 or software to erase the authorization and transaction information. While the method of FIG. 4 indicates erasing all authorization and transaction information, in some systems, other security features or alarms may alternatively or additionally be performed at block 410.

If, at block 406, no session counter or command errors are detected, the transaction monitor 221 may move to block 408. At block 408, the transaction monitor 221 may determine whether a final command has been transmitted or received. Where a final command has been transmitted or received, the method may move to block 410, where the transaction monitor 221 may erase all authorization and transaction information stored in the secure memory 220. For example, the transaction monitor 221 may erase one or more of information stored, tracked, or recorded by secure session counter 212, security keys used for a transaction, access conditions, credentials acquired to be used in the transaction, any temporary intermediate calculations stored for the transaction or used to generate the digital signature, and various other information. By running the transaction monitor 221 in parallel with the transaction module 210, and by tracking the final command or digital signature in this parallel manner, the system 160 may prevent a hacker from intercepting and modifying or cancelling a final command or digital signature prior to the completion of the transaction.

If, at block 408, no final command has been transmitted or received, the method may return to block 404, where the transaction monitor 221 may monitor the transaction module 210 and the session counter 212. The steps of the method of FIG. 4 may be repeated continuously, at specified time intervals, at the performance of one or more functions such as when a counter is incremented, when a threshold level is reached, or at various other times or points. In some methods, blocks 406 and 408 may be performed at the same time, or in either order. In some methods, blocks 406 and 408 may be continuously performed, such that the method may always monitor the transaction module 210 and the session counter 212 in block 404 until either a session counter error is detected or a final command is received. Various other examples are possible.

In some methods, the transaction monitor 221 may also or alternatively monitor when a transaction is aborted. For example, in some systems 160, a requester may choose to abort a transaction, and may input an abort message or other input to the system 160. The transaction monitor 221 may monitor or detect the abort input. Where an abort input is received and detected by the transaction monitor 221, the transaction monitor may erase all authorization and transaction information, as discussed in block 410. Various other examples are possible.

Transactions may be performed by one or more users over the network 110. The network 110 may include wide area networks (“WAN”), such as the Internet, local area networks (“LAN”), campus area networks, metropolitan area networks, wireless networks, wired networks, a direct connection such as through a Universal Serial Bus (“USB”) port, or any other networks that may allow for data communication. The network 110 may be regarded as a public or private network connection and may include, for example, a virtual private network or an encryption or other security mechanism employed over the public Internet, or the like.

A memory 206 that may be used with system 160 may be a main memory, a static memory, or a dynamic memory. The memory 206 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. Where the memory 206 includes a computer-readable medium, the computer-readable medium may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The “computer-readable medium” may be non-transitory, and may be tangible.

In one embodiment, the memory 206 includes a cache or random access memory for the processor 204. In alternative embodiments, the memory 206 is separate from the processor 204, such as a cache memory of a processor, the system memory, or other memory. The memory 206 may be an external storage device or database for storing data. Examples include a hard drive, CD, DVD, memory card, memory stick, floppy disc, universal serial bus (“USB”) memory device, or any other device operative to store data.

The methods, devices, and logic described above may be implemented in many different ways in many different combinations of hardware, software, and firmware, or various combinations of hardware, software, and firmware. For example, all or parts of the system may include circuitry in a controller, a microprocessor, or an ASIC, or may be implemented with discrete logic or components, or a combination of other types of analog or digital circuitry, combined on a single integrated circuit or distributed among multiple integrated circuits. All or part of the logic 208 may be implemented as instructions for execution by a processor 204, controller, or other processing device and may be stored in a tangible or non-transitory machine-readable or computer-readable medium as described. Thus, a product, such as a computer program product, may include a storage medium and computer readable instructions stored on the medium, which when executed in an endpoint, computer system, or other device, cause the device to perform operations according to any of the description above. The logic 208 may include an operating system, application program, firmware, or other logic. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (“DLL”)). The DLL, for example, may store code that performs any of the system processing described above.

The systems and methods described in here may provide many advantages to a user. The systems and method may provide a secure system for performing transactions. The systems and methods may provide a transaction monitor 221 to track and monitor transaction information being received and transmitted from a transaction module 210 in parallel, and to erase all personal, authorization, or transactional information immediately upon completion of one transaction. The systems and methods may prevent hackers from infiltrating and performing unauthorized transactions using information input by a user. The systems and methods may eliminate all data stored and/or necessary for a transaction immediately after the transaction to avoid this theft or unauthorized use of this information. Various other advantages or benefits may be possible.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system for performing a transaction, comprising:
a transaction module configured to gather authorization information necessary to perform a transaction, the transaction module configured to perform the transaction when a final instruction is received;
a secure memory configured to store the gathered authorization information; and
a transaction monitor configured monitor the transaction module and detect the received final instruction, where the transaction monitor erases the gathered authorization information from the secure memory when the received final instruction is detected.

2. The system of claim 1, further comprising a session counter configured to track a transaction parameter of the transaction, where the transaction monitor is configured to monitor the session counter.

3. The system of claim 2, where the session counter is configured to track a duration of the transaction, where the transaction monitor erases the gathered authorization information from the secure memory when the duration of the transaction exceeds a maximum duration threshold.

4. The system of claim 3, where session counter is configured to adjust the maximum duration threshold based on a type of the transaction.

5. The system of claim 2, where the session counter is configured to track an order of actions of the transaction, where the transaction monitor erases the gathered authorization information from the secure memory when the tracked order of actions does not match a required order of actions.

6. The system of claim 1, where the secure memory is configured to store the gathered authorized information in a first format and in a second format.

7. The system of claim 6, where the secure memory is configured to store the gathered authorized information in the first format at a first location, and the gathered authorized information in the second format at a second location.

8. The system of claim 6, where the first format represents an inverse of the second format.

9. A method of performing a transaction, comprising:
receiving a transaction request to perform a transaction;
gathering authorization information necessary to perform the transaction;
storing the authorization information in a secure memory;
receiving a final command to perform the transaction; and
erasing the stored authorization information in the secure memory when the final command is received.

10. The method of claim 9, further comprising:
performing the transaction when the final command is received.

11. The method of claim 9, further comprising:
comparing the gathered authorization information with expected authorization information; and
performing a security action when the gathered authorization information does not match the expected authorization information.

12. The method of claim 11, where the security action comprises erasing the stored authorization information in the secure memory.

13. The method of claim 9, where the authorization information includes a transaction key.

14. The method of claim 13, further comprising:
verifying the transaction key is valid;
erasing the stored authorization information in the secure memory when the transaction key is not valid; and
performing the transaction when the final command is received and the transaction key is valid.

15. The method of claim 13, where the transaction key includes a code and a piece of personal identification information.

16. A method of performing a transaction, comprising:
storing authorization information necessary to perform the transaction in a secure memory;
timing a duration of the transaction with a session counter;
comparing the timed duration to a maximum duration threshold;
tracking an order of operations of the transaction with the session counter;
comparing the tracked order of operations to a required order of operations; and
erasing the stored authorization information from the secure memory when the timed duration exceeds the maximum duration threshold or the tracked order of operations does not match the required order of operation.

17. The method of claim 16, further comprising performing an integrity check on the secure memory prior to storing the authorization information.

18. The method of claim 16, further comprising:
receiving a final command to perform the transaction; and
erasing the stored authorization information from the secure memory when the final command is received.

19. The method of claim 18, further comprising performing the transaction when the timed duration does not exceed the maximum duration threshold, the tracked order of operations matches the required order of operation, and the final command is received.

20. The method of claim 16, further comprising:
determining a type of the transaction; and
setting the maximum duration threshold based on the determined type of the transaction.
